(19) United States
(12) Patent Application Publication
(10) Pub. No.: US 2007/0273844 A1
(43) Pub. Date: Nov. 29, 2007

(54) Support for a cantilevered lens assembly

(76) Inventors: Stephan R. Clark, Corvallis, OR (US); Lawrence J. Gianola, Salem, OR (US); Franz Jurva, Corvallis, OR (US); Jon A. Bartman, Corvallis, OR (US); P. Guy Howard, Junction City, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/441,369

(22) Filed: May 25, 2006

(51) Int. Cl. G03B 21/14

(52) U.S. Cl. 353/100

(57) ABSTRACT

A exemplary system embodiment for supporting a cantilevered lens assembly positioned in a projection display device includes a first support member and a second support member. The first support member is configured to be coupled to the projection display device and is shaped to receive a portion of the cantilevered lens assembly. The second support member is configured for coupling the cantilevered lens assembly to the projection display device.

### BACKGROUND

Projection lens housings are typically cylindrical in form, with no specific feature to reduce sensitivity to the effects of vibration. Cantilevered lens assemblies have become commonplace in the rear projection television (RPTV) and/or (MDTV) industry. A cantilevered lens assembly requires additional support because any cantilevered item, is subject to the effects of deflection and/or vibration due its distance from the point of support. Thus, this sort of structure has a very weak or minimally supported moment. This can also be said to be due to the fact that the center of gravity of the device is distant from its stiffest support mechanism. Traditional lens assembly techniques alone are not sufficient to the reduce influence of deflection and/or vibration that a projection lens is exposed to in a relatively high vibration environment. Possible sources of vibration may include but are not limited to image dithering/scanning devices, integral speakers possibly including a sub-woofer, fans, color filter wheel motors, and the like.

### DRAWINGS

FIG. 1 is an exemplary side schematic view of a projection display device that includes a cantilevered lens assembly.

FIG. 2 is an exemplary top schematic view of a projection display device that includes a cantilevered lens assembly

FIG. 3 is an exemplary first side schematic view of the projection display device of FIG. 1 that incorporates a system of support members according to an embodiment.

FIG. 4 is an exemplary top schematic view of the projection display device of FIG. 1 that incorporates a system of support members according to an embodiment.

FIG. 5 is an exemplary second side schematic view of the projection display device of FIG. 1 that incorporates a system of support members according to an embodiment.

FIG. 6 is an exemplary perspective view of a first support member from FIGS. 3-5 according to an embodiment.

FIG. 7 is an exemplary perspective view of a second support member from FIG. 3 according to an embodiment.

FIG. 8 is an exemplary perspective view of a third support member from FIG. 5 according to an embodiment.

FIG. 9 is an exemplary flow diagram illustrating steps taken to implement an embodiment.

### DETAILED DESCRIPTION

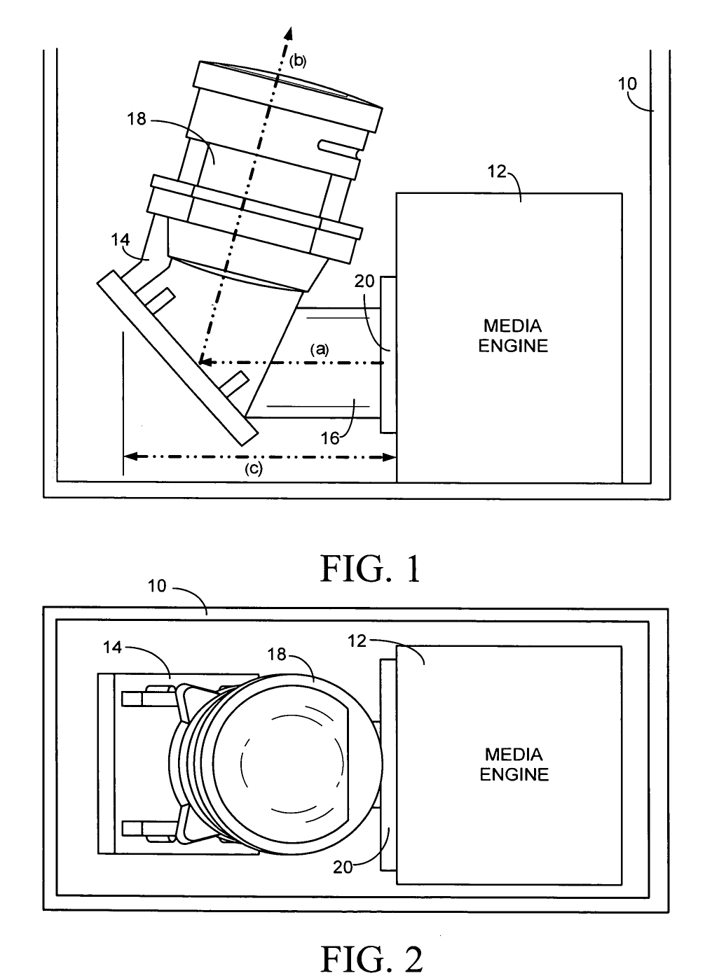

Referring to FIG. 1, projection display device 10 is shown to include media engine 12 and cantilevered lens assembly 14. Media engine 12, an internal structure of projection display device 10, represents generally any combination of hardware and/programming capable of utilizing cantilevered lens assembly 14 to project images on a target (not shown). Media engine 12 may also be configured to generated audible sounds. As an example, media engine 12 may be configured to receive a multimedia signal from an external source such as a DVD player or Cable or Satellite receiver. Media engine 12 processes that signal to generate images projected by cantilevered lens assembly 14 as well as any audible sounds.

In the example of FIGS. 1 and 2, cantilevered lens assembly 14 represents generally a housing encompassing a configuration of lenses and mirrors configured to project and focus images generated by media engines onto a target. Lens assembly 14 includes a first part 16 and a second part 18. First part 16 is configured for projecting images from media engine 12 along a first axis (a) and to reflect those images so that they are projected along a second axis (b) through second part 18. It is noted that axis (a) is not parallel to axis (b). Cantilevered lens assembly 14 is coupled to media engine 12 at support point 20.

Here, cantilevered lens assembly 14 is subject to the effects of deflection and/or vibration due its lateral extension (c) from support point 20 because of a relatively weak or minimally supported moment. In other words, the quality of images projected using cantilevered lens assembly 14 can be degraded by undesirable vibrations. Media engine 12 for example could be a possible source of vibration where, for example, media engine 12 includes an image dithering/scanning devices, integral speakers, fans, color filter wheel motors, and the like.

Various embodiments operate to support a cantilevered lens assembly dampening vibration caused by one or more components of a projection display device. Although the various embodiments of the invention disclosed herein will be described with reference to a projection display device such as a rear projection television or a micro-display television, the invention is not so limited. Embodiments may be implemented in any environment that utilizes a cantilevered lens assembly of any type and configuration.

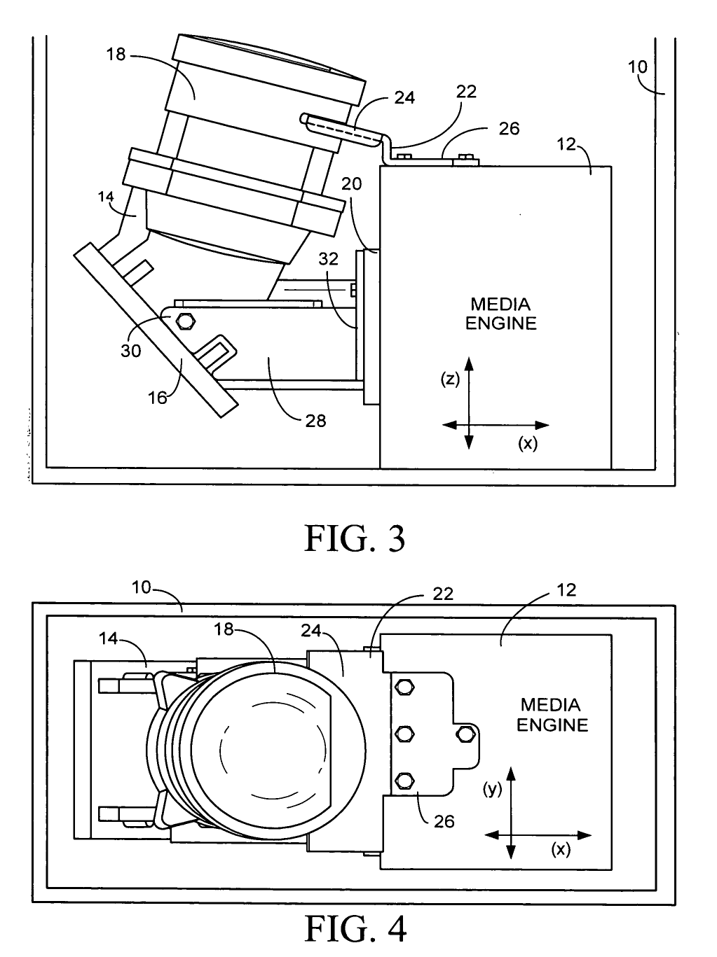

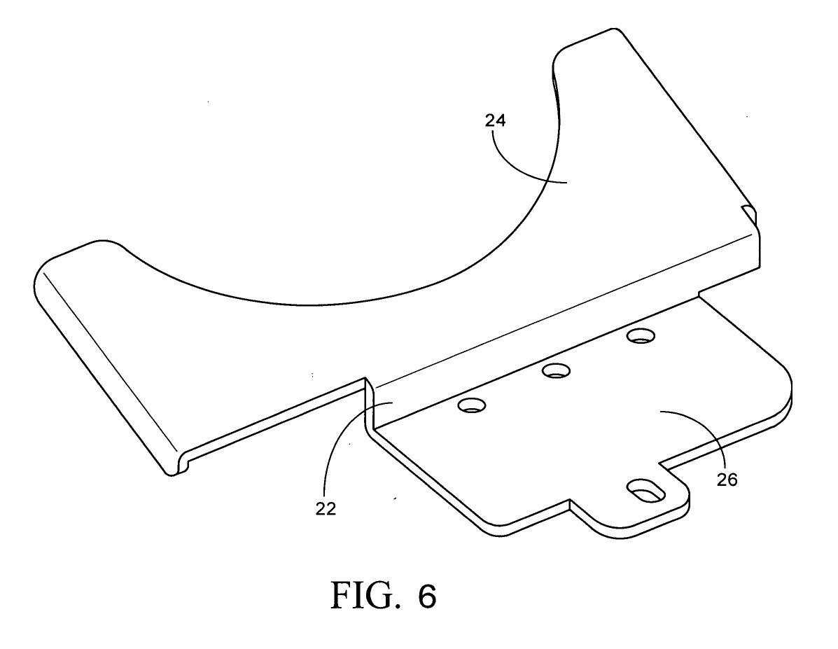

The components of various exemplary embodiments will now be described with reference to the exemplary diagrams of FIGS. 3-8. FIGS. 3-8 illustrate the projection display device 10 of FIG. 1 in which a system of support members are used to support cantilevered lens assembly 14.

Referring first to FIGS. 3-6, the system of support members includes first support member 22 which includes a first end 24 shaped to receive a portion of cantilevered lens assembly 14 and a second end 26 configured to be coupled to projection display device 10. In the particular example of FIGS. 3-6, first end 24 is shaped to receive a portion of second part 18 of cantilevered lens assembly 14. Second end 26 of first support member 22 is shown coupled to projection display device 10 via, in this example, media engine 12.

As shown, second part 18 of cantilevered lens assembly 14 has a curved surface and first end 24 of first support member is also curved to receive and collar or otherwise engage at least a portion of that curved surface. In another example, not shown, second part 18 may include a multifaceted surface. In such as case, first end 24 would be shaped to receive and engage two or more of those facets.

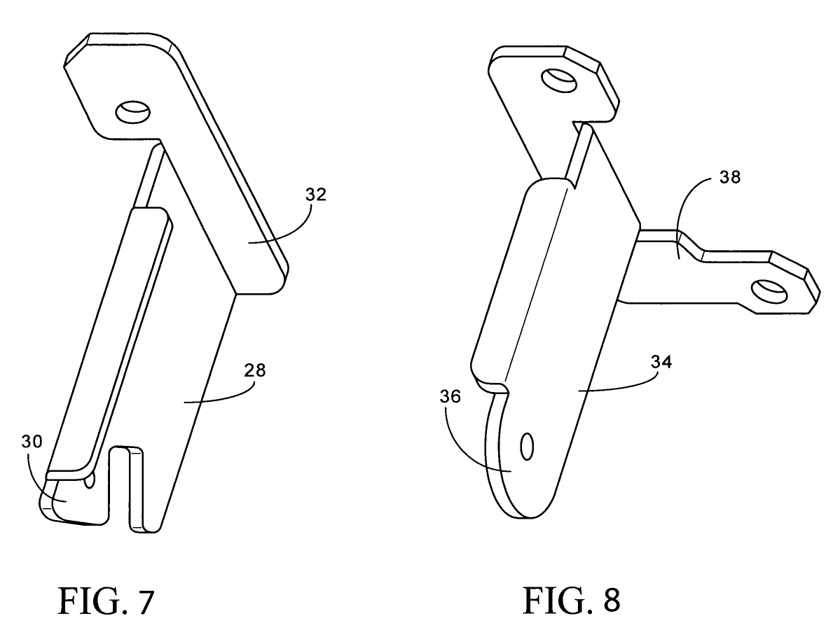

Referring next to FIGS. 3 and 7, the system of support members includes second support member 28 which includes a first end 30 configured to be coupled to cantilevered lens assembly 14 and a second end 30 configured to be coupled to projection display device 10. In the particular example of FIGS. 3-5 and 7, first end 30 is shaped to be coupled or otherwise fixed to first part 16 of cantilevered lens assembly 14. Second end 32 of second support member 28 is shown coupled to media engine 12. In other words, second support member 28 couples the cantilevered lens assembly 14 to projection display device 10 via, in this example, media engine 12.

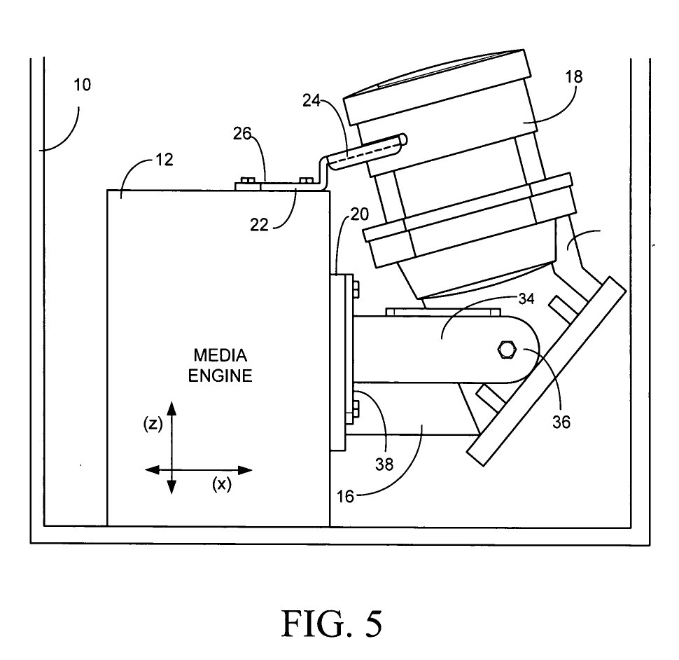

Referring next to FIGS. 5 and 8, the system of support members includes third support member 34 which includes a first end 36 configured to be coupled to cantilevered lens assembly 14 and a second end 38 configured to be coupled to projection display device 10. In the particular example of FIGS. 3-5 and 8, first end 34 is shaped to be coupled or otherwise fixed to first part 16 of cantilevered lens assembly 14. Second end 38 of first support member 22 is shown coupled to media engine 12. In other words, third support member 34 couples the cantilevered lens assembly 14 to projection display device 10 via, in this example, media engine 12.

As can be seen in the examples of FIGS. 3-5, at least a significant portion of first support member 22 is parallel to x-y plane. Second and third supporting members 28 and 34 each include a significant portion that is generally parallel to the x-z plane.—the x-z plane being orthogonal to the x-y plane. With first end 24 of first supporting member 22 receiving second part 18 of cantilevered lens assembly 13 and second end 26 fixed to projection display device 10 via media engine 12, first support member 22 helps to prevent cantilevered lens assembly 14 from pivoting or twisting around the (x) axis and stops translation in the (y) axis due to any vibrations caused by media engine 12. With one or both of second and third support members 28 and 34 coupling cantilevered lens assembly 14 to projection display device 10, second and third' support members 28 and 34 help to prevent cantilevered lens assembly 14 from pivoting in the x-z plane due to any vibrations caused by media engine 12.

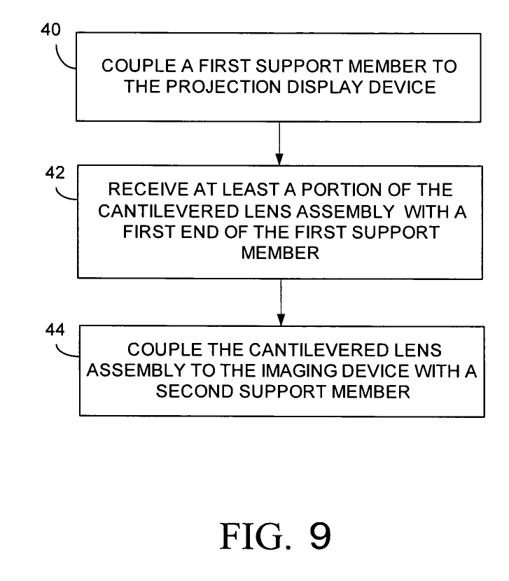

An exemplary method for supporting a cantilevered lens assembly will now be described with reference to the flow diagram of FIG. 9. The cantilevered lens assembly is a component of a projection display device such as a rear projection television. A first support member is coupled to one or more internal components of the image projection device (step 40). At least a portion of the cantilevered lens assembly is received with a first end of the support member (step 42). The first end of the first support member is shaped to receive that portion of the cantilevered lens assembly. The cantilevered lens assembly is then coupled to projection display device with a second support member (step 44).

In an another method embodiment, an additional step might include coupling the cantilevered lens assembly to the projection display device with a third support member. Furthermore, the cantilevered lens assembly may include a first part and a second part where the first part has a first axis along which images are projected, the second part having a second axis along which images are projected that is not parallel with the first axis. In such a case, step 40 may include receiving at least a portion of the first part with the first end of the first support member. In addition step 42 may include coupling the second part of the cantilevered lens assembly to the projection display device with the second support member and perhaps even the third support member.

### CONCLUSION

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for supporting a cantilevered lens assembly positioned in a projection display device, comprising:
coupling a first support member to the projection display device;
receiving at least a portion the cantilevered lens assembly with a first end of the first support member, the first end being shaped to receive the portion; and
coupling the cantilevered lens assembly to the projection display device with a second support member.

2. The method of claim 1, further comprising coupling the cantilevered lens assembly to the projection display device with a third support member.

3. The method of claim 1 wherein:
the cantilevered lens assembly has a first part and a second part, the first part having a first axis along which images are projected, the second part having a second axis along which images are projected that is not parallel with the first axis; and
receiving comprises receiving at least a portion of the first part with the first end of a first support member.

4. The method of claim 3, wherein coupling the surface of the cantilevered lens assembly to the projection display device comprises coupling the second part of the cantilevered lens assembly to the projection display device with the second support member.

5. The method of claim 4, wherein the first support member is generally parallel to a first plane, the second support member is generally parallel to a second plane that is substantially orthogonal to the first plane.

6. The method of claim 4, further comprising coupling the second part of the cantilevered lens assembly to the projection display device with a third support member.

7. The method of claim 3, wherein the portion of the second part of the cantilevered lens assembly received by the first support member includes a curved surface, and wherein receiving at least a portion of the first part comprises receiving at least a portion of the curved surface with the first end of the first support member, the first end being shaped to receive the portion of the curved surface.

8. The method of claim 3, wherein the portion of the second part of the cantilevered lens assembly received by the first support member includes a multifaceted surface, and wherein receiving at least a portion of the first part comprises receiving at least portions of at least two of the facets with the first end of the first support member, the first end being shaped to receive the portions of the at least two facets.

9. A system for supporting a cantilevered lens assembly positioned in a projection display device, comprising:
a first support member configured to be coupled to the projection display device, the first support member shaped to receive a portion of the cantilevered lens assembly; and
a second support member configured for coupling the cantilevered lens assembly to the projection display device.

10. The system of claim 9, further comprising a third support member coupling the cantilevered lens assembly to the projection display device.

11. The system of claim 9, wherein:
the cantilevered lens assembly has a first part and a second part, the first part having a first axis along which images are projected, the second part having a second axis along which images are projected that is not parallel with the first axis; and
the first support member is shaped to at least a portion of the first part of the cantilevered lens assembly.

12. The system of claim 11, wherein the second support member is configured for coupling the second part of the cantilevered lens assembly to the projection display device.

13. The system of claim 12, further comprising a third support member configured for coupling the second part of the cantilevered lens assembly to the projection display device.

14. The system of claim 11, wherein the portion of the second part of the cantilevered lens assembly received by the first support member includes a curved surface, and wherein the first support member is shaped to receive at least a portion of the curved surface.

15. The system of claim 11, wherein the portion of the second part of the cantilevered lens assembly received by the first support member includes a multifaceted surface, and wherein the first support member is shaped to receive at least portions of two or more of the facets.

16. A projection display device, comprising:
a cantilevered lens assembly configured to focus images on a target wherein the cantilevered lens assembly includes a first part and a second part, the first part having a first axis along which images are projected, the second part having a second axis along which images are projected that is not parallel with the first axis;
a first support member shaped to receive a portion of the first part of cantilevered lens assembly; and
a second support member coupled to the second part of the cantilevered lens assembly;
wherein the first and second support members are each coupled to at least one of one or more internal structures of the projection display device.

17. The device of claim 16, wherein the first support member is generally parallel to a first plane and the second support member is generally parallel to a second plane that is substantially orthogonal to the first plane.

18. The device of claim 16, further comprising a third support member coupling the second part of the cantilevered lens assembly to at least one of the one or more internal structures.

19. The device of claim 16, wherein the portion of the second part of the cantilevered lens assembly received by the first support member includes a curved surface, and wherein the first support member is shaped to receive at least a portion of the curved surface.

20. The device of claim 16, wherein the portion of the second part of the cantilevered lens assembly received by the first support member includes a multifaceted surface and wherein the first support member is shaped to receive at least portions of two or more of the facets.
